(19) United States
(12) Patent Application Publication
(10) Pub. No.: US 2019/0147855 A1
(43) Pub. Date: May 16, 2019

(54) NEURAL NETWORK FOR USE IN SPEECH RECOGNITION ARBITRATION

(71) Applicant: GM GLOBAL TECHNOLOGY OPERATIONS LLC, Detroit, MI (US)

(72) Inventors: Xu Fang Zhao, LaSalle (CA); Gaurav Talwar, Novi, MI (US)

(21) Appl. No.: 15/811,022

(22) Filed: Nov. 13, 2017

(51) Int. Cl. G10L 15/16; G10L 15/06; G10L 15/14; G10L 15/22; G06N 3/08

(52) U.S. Cl. CPC G10L 15/16; G10L 15/063; G06N 3/08; G10L 15/22; G10L 15/142

(57) ABSTRACT

A system and method of performing speech arbitration at a client device that includes a neural network speech arbitration application, wherein the neural network speech arbitration application is configured to implement a neural network speech arbitration process, and wherein the method includes: receiving speech signals at a client device; generating and/or obtaining a set of inputs to be used in a speech arbitration neural network process, wherein the speech arbitration neural network process uses a neural network model that is tailored to speech arbitration and that can be used to determine whether and/or to what extent speech recognition processing of the received speech signals should be carried out at the client device; and receiving a speech arbitration output that indicates whether and/or to what extent the speech recognition processing of the received speech signals is to be carried out at the client device or at the remote server.

### INTRODUCTION

The present invention relates to speech arbitration and, more particularly, to implementing a speech arbitration process that uses a neural network model for determining whether and/or to what extent to use a first automated speech recognition (ASR) system at the client-side and a second ASR system at the server-side.

A variety of vehicle functions may be controlled or services obtained at a vehicle or other client speech recognition device using automatic speech recognition (ASR). For example, vehicles include hardware and software capable of receiving speech from a vehicle occupant, processing that speech to understand speech content, and then carrying out some action based on the speech content. The vehicles or other client devices can use the hardware and software to process received speech solely at the vehicle. Alternatively, the vehicle can send the received speech as packetized data to a remote facility where the speech recognition processing occurs. The remote facility can then respond to the vehicle with a speech recognition analysis. Performing speech recognition at each location has its advantages and it would be helpful to identify conditions when it is more advantageous to send speech to the remote facility rather than performing speech recognition at the vehicle.

### SUMMARY

According to one aspect of the invention, there is provided a method of performing speech arbitration at a client device that includes a neural network speech arbitration application, wherein the neural network speech arbitration application is configured to implement a neural network speech arbitration process, and wherein the method includes: receiving speech signals at a client device; generating and/or obtaining a set of inputs to be used in a speech arbitration neural network process, wherein the speech arbitration neural network process uses a neural network model that is tailored to speech arbitration and that can be used to determine whether and/or to what extent speech recognition processing of the received speech signals should be carried out at the client device or at a remote server; and receiving a speech arbitration output that indicates whether and/or to what extent the speech recognition processing of the received speech signals is to be carried out at the client device or at the remote server.

According to various embodiments, this method may further include any one of the following features or any technically-feasible combination of these features:
the set of inputs includes conditional input that is generated based on receiving feedback from one or more previous iterations of the speech arbitration neural network process;
the set of inputs further includes a connectivity quality metric that indicates a quality of service and/or a connection quality between the client device and the remote server;
the set of inputs further includes a confidence score that is generated based on the received speech signals and that indicates a confidence level pertaining to the client device's ability to successfully recognize spoken words conveyed in the received speech signals;
the set of inputs further includes an engine bias metric that is used to bias the speech arbitration neural network process so that the client device or the remote server is more likely to be used for the speech recognition processing of the received speech signals;
the speech arbitration neural network process is based on a deep neural network model that includes a plurality of hidden neural network layers that are used to map the set of inputs to the speech arbitration output;
the speech arbitration neural network process is initially trained using speech recognition output that is obtained as a result of a rule-based speech arbitration process; and/or
the speech arbitration neural network process uses the speech arbitration output for purposes of training the speech arbitration neural network process so as to improve the neural network speech arbitration process for future iterations.

According to another aspect of the invention, there is provided a method of performing speech arbitration at a client device that includes a neural network speech arbitration application, the method including: training the neural network speech arbitration application using training data that is obtained as a result of a rule-based speech arbitration process; carrying out an iteration of the neural network speech arbitration application at the client device such that speech arbitration is performed, wherein the neural network speech arbitration application uses an artificial neural network model to resolve a set of inputs to a speech arbitration output, and wherein the speech arbitration output indicates whether and/or to what extent to perform speech recognition processing of received speech at a remote server that includes an automated speech recognition (ASR) system; and adapting the neural network speech arbitration application based on previous iterations of the neural network speech arbitration application.

According to various embodiments, this method may further include any one of the following features or any technically-feasible combination of these features:
the set of inputs includes a confidence score, a connectivity quality metric, an engine bias metric, and conditional input, and wherein the conditional input is based on previous iterations of the neural network speech arbitration application;
the conditional input is at least partly based on speech arbitration inputs and outputs that are used or obtained as part of previous iterations of the neural network speech arbitration application;
the adapting step further comprises adapting the neural network speech arbitration application based on the set of inputs, the speech arbitration output, and a measured success of the neural network speech arbitration application;
the measured success of the neural network speech arbitration process is determined automatically by the client device based on one or more performance indicators;
the training step further includes performing supervised training on the neural network speech arbitration application using the training data that is obtained as the result of the rule-based speech arbitration process;
the training step is carried out before the neural network speech arbitration application is installed and configured for use in the client device; and/or
the network speech arbitration application is occasionally updated through receiving information at the client device from a remotely-located server.

According to yet another aspect of the invention, there is provided a method of performing speech arbitration at a client device that includes a neural network speech arbitration application, wherein the method is carried out by a vehicle that includes a first automated speech recognition (ASR) system, and wherein the method includes: training the neural network speech arbitration application using training data; carrying out a plurality of iterations of the neural network speech arbitration application at the client device such that speech arbitration is performed, wherein each iteration of the plurality of iterations includes: (i) receiving speech signals at the vehicle; (ii) generating and/or obtaining a set of inputs to be used in a speech arbitration neural network process; and (iii) receiving a speech arbitration output that indicates whether and/or to what extent the speech recognition processing of the received speech signals is to be carried out at the vehicle or at a remote server that includes a second ASR system; and adapting the neural network speech arbitration application based on the plurality of iterations of the neural network speech arbitration application.

According to various embodiments, this method may further include any one of the following features or any technically-feasible combination of these features:
the set of inputs includes a confidence score, a connectivity quality metric, an engine bias metric, and conditional input, wherein the conditional input is based on previous iterations of the neural network speech arbitration application;
the training data is obtained as a result of a rule-based speech arbitration process; and/or
the training step further includes performing supervised training on the neural network speech arbitration application using the training data that is obtained as the result of the rule-based speech arbitration process, and wherein the training step is carried out before the neural network speech arbitration application is installed and configured for use in the client device.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a block diagram depicting an embodiment of an automatic speech recognition (ASR) system;

FIG. 3 is a flow chart of an embodiment of a method of performing speech arbitration at a client device that includes a neural network speech arbitration application; and

FIG. 4 is a block diagram depicting an embodiment of a neural network model that can be used in a neural network speech arbitration process or application.

### DETAILED DESCRIPTION OF THE ILLUSTRATED EMBODIMENT(S)

The system and method described below involves receiving speech at a client device and performing speech arbitration according to a neural network model to determine whether to perform speech recognition at the client device or a remote speech processing server. For example, a processing device included in or located at the client device can be configured to operate according to a particular neural network model that is tailored to perform speech arbitration for the purposes of determining whether and/or to what extent speech processing of received speech should be performed at the client device using an “on-board” or “client-side” speech processing system, or whether and/or to what extent the speech processing of the received speech should be performed at a remote speech processing server, such as those that may be accessible via an interconnected network (e.g., the Internet).

As used herein, “speech arbitration” refers to the determination of whether and/or to what extent speech processing should be performed at a client device or at a remote speech processing facility. As used herein, “neural network model” refers to an artificial neural network that includes mapping an input comprised of various factors (or inputs) to an output using at least one hidden layer that interconnects or maps varying input values and/or conditions to an output. The methods and systems below implement a neural network model for purposes of speech arbitration. In many embodiments, various factors can be obtained and inputted into a specifically-tailored speech arbitration neural network model so as to determine whether and/or to what extent speech processing of received speech should be performed at a client device or at a remote speech processing server.

In one embodiment, the client device can receive speech using a microphone. Thereafter, the client device can obtain a set of inputs, including a confidence score, a connectivity quality metric, an engine bias metric, and conditional input, and, subsequently, can use a neural network speech arbitration application to determine whether and/or to what extent speech processing of the received speech should be performed at the client device or at a remote speech processing server. The neural network speech arbitration application may be initially configured using speech arbitration information (or training information) that was gathered according to a rule-based speech arbitration process and, once in operation, the neural network speech arbitration application can adapt based on feedback information that is gathered during or after speech arbitration iterations (i.e., cycles of operation using the neural network speech arbitration application). The feedback information can include or be based on certain inputs used during a given speech arbitration iteration, outputs of the speech arbitration iteration, and/or one or more quality or performance indicators that represent the quality and/or success of the output of the speech arbitration iteration.

As those skilled in the art will appreciate, the neural network-based speech arbitration process or application can be implemented into a variety of different client devices, including handheld mobile devices (e.g., smartphones), home automation devices (e.g., intelligent personal assistants such as Amazon™ Alexa™ and Google™ Home), vehicles, and/or any device that can receive speech, connect to a remote computer network, and be configured to implement the neural network-based speech arbitration process or application discussed herein. In a particular embodiment, a vehicle can be used as a client device to receive and perform speech arbitration, and a remote speech processing server, such as those included in a vehicle backend services facility, can be used for speech processing to the extent that the vehicle determines, as a result of the neural network-based speech arbitration process or application, to send speech signals to the vehicle backend services facility. Other embodiments exist, such as where there is a plurality of remote ASR systems and, in such cases, the neural network speech arbitration model can be used to determine whether and/or to what extent speech signals should be sent to one or more of the plurality of ASR systems.

Depending on a number of factors relating to the content of the speech received or the quality of the wireless communications available at the vehicle, it may be advantageous to process the speech either at the vehicle or the remote facility. For example, the disadvantages of sending speech to a remote facility involve the use fees charged by wireless carrier systems for sending speech from the vehicle to the remote facility. Each time the vehicle sends speech to be analyzed by the remote facility, the vehicle or telematics service provider incurs a charge for doing so. This charge could be based on the length of time needed to send the speech, the amount of data the speech includes, or both. On the other hand, remote facilities that receive speech from the vehicle can maintain more powerful computer processing capabilities drawing on language models that are more sophisticated than what may be available on the vehicle. Vehicle-based speech processing may have its own disadvantages. While recognizing received speech at the vehicle may minimize the fees charged by wireless carrier systems, the vehicle's computer processing capabilities may be less powerful than those available at the remote facility and the vehicle may use simpler language models that may include less content than what may be available at the remote facility, which may mean less accurate results. The neural network speech arbitration process discussed below can perform speech arbitration based on a variety of factors, such as factors associated with any one or more of the disadvantages or advantages of the vehicle (or client device) and the remote speech processing server, as discussed above. And, at least in some embodiments, the neural network speech arbitration process can adapt based on previous iterations of the neural network speech arbitration process so as to improve the speech recognition processing.

The factors that play into how successful a given speech recognition process may vary and, thus, providing a set of rules for speech arbitration may not be sufficient or ideal in some situations. For example, not all speech received at the vehicle from vehicle occupants is uniform and, additionally, the quality of service offered by the wireless carrier system used to send the speech content can vary based on present cellular connectivity and/or server loads or traffic. The speech content can depend on the context of the commands given by the vehicle occupant and vary in content or length. Also, the quality of service offered by the wireless carrier system can make sending speech from the vehicle to the remote facility more or less attractive. The speech received at the vehicle can be analyzed to assess the factors related to speech content, quality of service, or both; and, based on assessing such factors, a decision can be reached about whether the speech should be sent to the remote facility for recognition, whether the vehicle should carry out speech recognition processing at the vehicle, or whether both ASR system should be used. All of these various factors can be inputted into the neural network speech arbitration process or application, which uses neural networking techniques, including at least one hidden neural network layer, to resolve the inputted factors to a speech arbitration output that can be used to indicate whether and/or to what extent speech processing of the received speech should be performed at the vehicle or at a remote speech processing server, such as those servers located at a vehicle backend services facility.

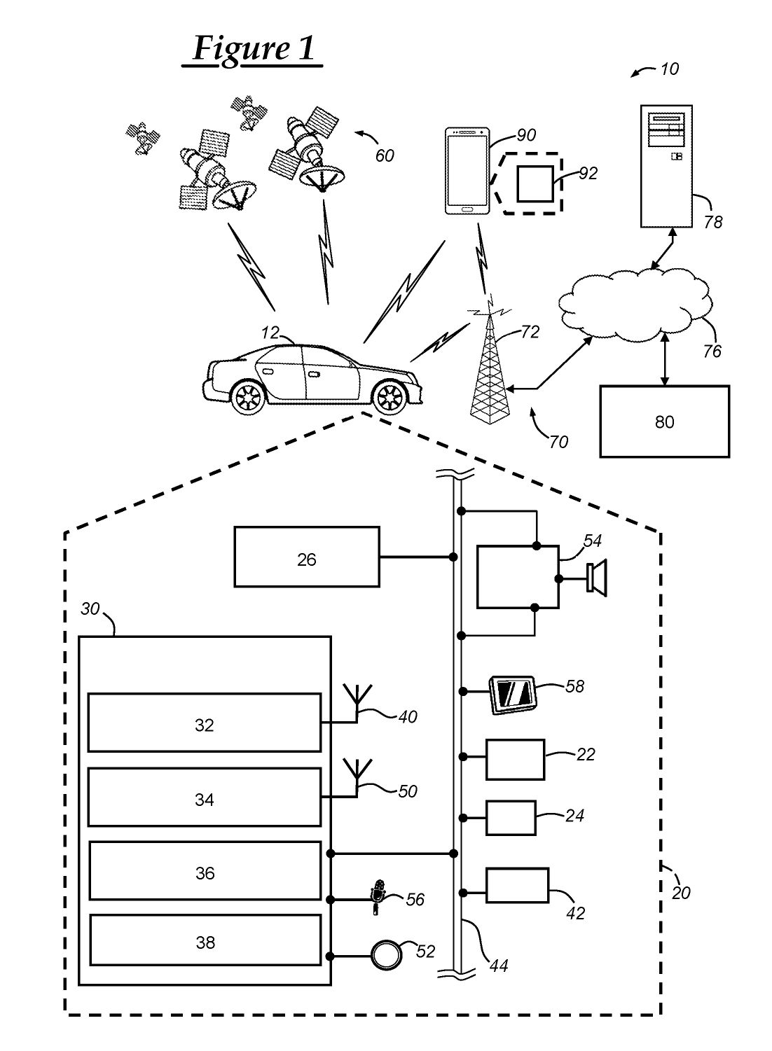

With reference to FIG. 1, there is shown an operating environment that comprises a communications system 10 and that can be used to implement the method disclosed herein. Communications system 10 generally includes a vehicle 12 with a body control module (BCM) 26 and a wireless communications device 30, a constellation of global navigation satellite system (GNSS) satellites 60, one or more wireless carrier systems 70, a land communications network 76, a computer 78, a remote facility 80, and a personal mobile device 90. It should be understood that the disclosed method can be used with any number of different systems and is not specifically limited to the operating environment shown here. Also, the architecture, construction, setup, and general operation of the system 10 and its individual components are generally known in the art. Thus, the following paragraphs simply provide a brief overview of one such communications system 10; however, other systems not shown here could employ the disclosed method as well.

Wireless carrier system 70 may be any suitable cellular telephone system. Carrier system 70 is shown as including a cellular tower 72; however, the carrier system 70 may include one or more of the following components (e.g., depending on the cellular technology): cellular towers, base transceiver stations, mobile switching centers, base station controllers, evolved nodes (e.g., eNodeBs), mobility management entities (MMEs), serving and PGN gateways, etc., as well as any other networking components required to connect wireless carrier system 70 with the land network 76 or to connect the wireless carrier system with user equipment (UEs, e.g., which can include telematics equipment in vehicle 12). Carrier system 70 can implement any suitable communications technology, including GSM/GPRS technology, CDMA or CDMA2000 technology, LTE technology, etc. In general, wireless carrier systems 70, their components, the arrangement of their components, the interaction between the components, etc. is generally known in the art.

Apart from using wireless carrier system 70, a different wireless carrier system in the form of satellite communication can be used to provide uni-directional or bi-directional communication with the vehicle. This can be done using one or more communication satellites (not shown) and an uplink transmitting station (not shown). Uni-directional communication can be, for example, satellite radio services, wherein programming content (news, music, etc.) is received by the uplink transmitting station, packaged for upload, and then sent to the satellite, which broadcasts the programming to subscribers. Bi-directional communication can be, for example, satellite telephony services using the one or more communication satellites to relay telephone communications between the vehicle 12 and the uplink transmitting station. If used, this satellite telephony can be utilized either in addition to or in lieu of wireless carrier system 70.

Land network 76 may be a conventional land-based telecommunications network that is connected to one or more landline telephones and connects wireless carrier system 70 to remote facility 80. For example, land network 76 may include a public switched telephone network (PSTN) such as that used to provide hardwired telephony, packet-switched data communications, and the Internet infrastructure. One or more segments of land network 76 could be implemented through the use of a standard wired network, a fiber or other optical network, a cable network, power lines, other wireless networks such as wireless local area networks (WLANs), or networks providing broadband wireless access (BWA), or any combination thereof.

Computers 78 (only one shown) can be some of a number of computers accessible via a private or public network such as the Internet. Each such computer 78 can be a client device that can perform speech processing and/or speech arbitration, or which can be used for one or more purposes, such as a remote server accessible (e.g., a remote speech processing server) by vehicle 12. Other such accessible computers 78 can be, for example: a third party server that can be used to provide location services; a service center computer where diagnostic information and other vehicle data can be uploaded from the vehicle; a client computer used by the vehicle owner or other subscriber for such purposes as accessing or receiving vehicle data or to setting up or configuring subscriber preferences or controlling vehicle functions; a car sharing server which coordinates registrations from a plurality of users who request to use a vehicle as part of a car sharing service; or a third party repository to or from which vehicle data or other information is provided, whether by communicating with the vehicle 12, remote facility 80, or both. A computer 78 can also be used for providing Internet connectivity such as DNS services or as a network address server that uses DHCP or other suitable protocol to assign an IP address to the vehicle 12.

Remote facility 80 may be designed to provide the vehicle electronics 20 and mobile device 90 with a number of different system back-end functions through use of one or more electronic servers. For example, remote facility 80 may be used in part to facilitate or coordinate information sent between vehicle 12 and one or more client devices, such as mobile device 90 or computer 78. In one embodiment, the remote facility 80 can provide speech recognition services, which can include receiving speech signals from a client device and processing the received speech signals using a speech recognition system. Additionally, or alternatively, the remote facility 80 may include one or more switches, servers, databases, live advisors, as well as an automated voice response system (VRS), all of which are known in the art. Remote facility 80 may include any or all of these various components and, preferably, each of the various components are coupled to one another via a wired or wireless local area network. Remote facility 80 may receive and transmit data via a modem connected to land network 76.

Remote facility 80 can also include one or more databases that can store account information such as subscriber authentication information, vehicle identifiers, profile records, behavioral patterns, speech recognition and/or arbitration information, and other pertinent subscriber information. As used herein, speech recognition and/or arbitration information includes information that can be used for training a speech recognition or speech arbitration system, such as the neural network speech arbitration process discussed in detail below. Data transmissions may also be conducted by wireless systems, such as IEEE 802.11x, GPRS, and the like. Those skilled in the art will appreciate that, although only one remote facility 80 and one computer 78 are depicted in the illustrated embodiment, numerous remote facilities 80 and/or computers 78 may be used.

The personal mobile device 90 is a mobile device and may include: hardware, software, and/or firmware enabling cellular telecommunications and SRWC as well as other mobile device applications. As used herein, a personal mobile device is a mobile device that is capable of SRWC, that is portable by a user, and where the portability of the device is at least partly dependent on the user, such as a wearable device (e.g., a smartwatch), an implantable device, or a handheld device (e.g., a smartphone, a tablet, a laptop). As used herein, a short-range wireless communications (SRWC) device is a device capable of SRWC. Personal mobile device 90 can be a client device and can include a processor and memory (e.g., non-transitory computer readable medium configured to operate with the processor) for storing the software, firmware, etc. The personal mobile device's processor and memory may enable various software applications 92, which may be preinstalled or installed by the user (or manufacturer) (e.g., having a software application or graphical user interface (GUI)).

One implementation of a mobile device application 92 may enable receiving speech and processing the received speech using speech recognition techniques, some of which may include speech arbitration according to various embodiments of the method discussed herein. For example, the mobile device can include a microphone that enables the reception of speech waves that are generated by one or more users. Speech arbitration can be carried out at the mobile device according to the neural network speech arbitration process discussed below. In some embodiments, application 92 or another mobile device application can include a graphical user interface that allows a user to enter credentials, submit credentials for authorization and/or authentication, connect to vehicle 12, view vehicle status information, request vehicle functions to be carried out, and/or configure one or more vehicle settings. Mobile device 90 may communicate with wireless communications device 30 according to one or more SRWC technologies or wired connections, such as a connection using a Universal Serial Bus (USB) cable. Although a single mobile device 90 is shown, communications 10 can include a plurality of mobile devices 90.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 20 are shown generally in FIG. 1 and includes a global navigation satellite system (GNSS) module 22, engine control unit (ECU) 24, a body control module (BCM) 26, a wireless communications device 30 that can be configured to perform neural network speech arbitration and/or speech recognition processing, other vehicle system modules (VSMs) 42, and numerous other components and devices. Some or all of the different vehicle electronics may be connected for communication with each other via one or more communication busses, such as bus 44. Communications bus 44 provides the vehicle electronics with network connections using one or more network protocols. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

The vehicle 12 can include numerous vehicle system modules (VSMs) as part of vehicle electronics 20, such as the GNSS module 22, ECU 24, BCM 26, wireless communications device 30, and vehicle user interfaces 52-58, as will be described in detail below. The vehicle 12 can also include other VSMs 42 in the form of electronic hardware components that are located throughout the vehicle and, which may receive input from one or more sensors and use the sensed input to perform diagnostic, monitoring, control, reporting, and/or other functions. Each of the VSMs 42 can be connected to the other VSMs via communications bus 44, and can be programmed to run vehicle system and subsystem diagnostic tests. One or more VSMs 42 may periodically or occasionally have their software or firmware updated and, in some embodiments, such vehicle updates may be over the air (OTA) updates that are received from a computer 78 or remote facility 80 via land network 76 and communications device 30. As is appreciated by those skilled in the art, the above-mentioned VSMs are only examples of some of the modules that may be used in vehicle 12, as numerous others are also possible.

Global navigation satellite system (GNSS) module 22 receives radio signals from a constellation of GNSS satellites. In one embodiment, the GNSS module 22 may be a global positioning system (GPS) module, which may receive GPS signals from a constellation of GPS satellites 60. From these signals, the module 22 can determine vehicle position which may enable the vehicle to determine whether it is at a known location, such as home or workplace. Moreover, GNSS module 22 can provide this location data (e.g., geographical coordinates) to wireless communications device 30, which can then use this data to identify known locations, such as a vehicle operator's home or workplace. Additionally, GNSS module 22 may be used to provide navigation and other position-related services to the vehicle operator. Navigation information can be presented on the display 58 (or other display within the vehicle) or can be presented verbally such as is done when supplying turn-by-turn navigation. The navigation services can be provided using a dedicated in-vehicle navigation module (which can be part of GNSS module 22), or some or all navigation services can be done via a telematics unit installed in the vehicle, wherein the position information is sent to a remote location for purposes of providing the vehicle with navigation maps, map annotations (points of interest, restaurants, etc.), route calculations, and the like. The location information can be supplied to remote facility 80 or other remote computer system, such as computer 78, for other purposes, such as fleet management and/or for use in a car sharing service. Also, new or updated map data can be downloaded to the GNSS module 22 from the remote facility 80 via a vehicle telematics unit.

Vehicle electronics 20 also includes a number of vehicle user interfaces that provide vehicle occupants with a means of providing and/or receiving information, including pushbutton(s) 52, audio system 54, microphone 56, and visual display 58. As used herein, the term “vehicle user interface” broadly includes any suitable form of electronic device, including both hardware and software components, which is located on the vehicle and enables a vehicle user to communicate with or through a component of the vehicle. The pushbutton(s) 52 allow manual user input into the communications device 30 to provide other data, response, or control input. Audio system 54 provides audio output to a vehicle occupant and can be a dedicated, stand-alone system or part of the primary vehicle audio system. According to the particular embodiment shown here, audio system 54 is operatively coupled to both vehicle bus 44 and an entertainment bus (not shown) and can provide AM, FM and satellite radio, CD, DVD and other multimedia functionality. This functionality can be provided in conjunction with or independent of an infotainment module. Microphone 56 provides audio input to the wireless communications device 30 to enable the driver or other occupant to provide voice commands and/or carry out hands-free calling via the wireless carrier system 70, and which can be processed using speech arbitration and recognition techniques, as discussed more below. Microphone 56 can be connected to an on-board automated voice processing unit utilizing human-machine interface (HMI) technology known in the art. Visual display or touch screen 58 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Body control module (BCM) 26 is shown in the exemplary embodiment of FIG. 1 as being electrically coupled to communication bus 44. In some embodiments, the BCM 26 may be integrated with or part of a center stack module (CSM) and/or integrated with wireless communications device 30. Or, the BCM and CSM may be separate devices that are connected to one another via bus 44. BCM 26 can include a processor and/or memory, which can be similar to processor 36 and memory 38 of wireless communications device 30, as discussed below. BCM 26 may communicate with wireless communications device 30 and/or one or more vehicle system modules, such as GNSS 22, audio system 54, or other VSMs 42. The processor and memory of BCM 36 can be used to direct or carry out one or more vehicle operations including, for example, controlling central locking, air conditioning, power mirrors, controlling the vehicle ignition or primary mover (e.g., engine, primary propulsion system), and/or controlling various other vehicle modules. BCM 26 may receive data from wireless communications device 30 and, subsequently, send the data to one or more vehicle modules.

Additionally, BCM 26 may provide information corresponding to the vehicle state or of certain vehicle components or systems. For example, the BCM may provide the wireless communications device 30 with information indicating whether the vehicle's ignition is turned on, the gear the vehicle is presently in (i.e. gear state), and/or other information regarding the vehicle. The BCM 26 may be used to determine one or more vehicle states, such as whether the vehicle is powered on, the battery power of a vehicle battery, and/or other vehicle states. These various vehicle states can be obtained wireless communications device 30 and used as an input in the neural network speech arbitration process.

Wireless communications device 30 is capable of communicating data via short-range wireless communications (SRWC) and, in some embodiments, may be capable of communicating data via cellular network communications. As shown in the exemplary embodiment of FIG. 1, wireless communications device 30 includes an SRWC circuit 32, a cellular chipset 34, a processor 36, memory 38, and antennas 40 and 50. In some embodiments, the wireless communications device 30 may be specifically configured to carry out at least part of the method disclosed herein. In one embodiment, wireless communications device 30 may be a standalone module or, in other embodiments, device 30 may be incorporated or included as a part of one or more other vehicle system modules, such as a center stack module (CSM), BCM 26, an infotainment module, a telematics unit, a head unit, and/or a gateway module. In some embodiments, the device 30 can be implemented as an OEM-installed (embedded) or aftermarket device that is installed in the vehicle.

Wireless communications device 30 can be configured to communicate wirelessly according to one or more wireless protocols, including short-range wireless communications (SRWC) such as any of the IEEE 802.11 protocols, Wi-Fi™ WiMAX™, ZigBee™, Wi-Fi Direct™, Bluetooth™, Bluetooth™ Low Energy (BLE), or near field communication (NFC). As used herein, Bluetooth™ refers to any of the Bluetooth™ technologies, such as Bluetooth Low Energy™ (BLE), Bluetooth™ 4.1, Bluetooth™ 4.2, Bluetooth™ 5.0, and other Bluetooth™ technologies that may be developed. As used herein, Wi-Fi™ or Wi-Fi™ technology refers to any of the Wi-Fi™ technologies, such as IEEE 802.11b/g/n/ac or any other IEEE 802.11 technology. The short-range wireless communication circuit 32 enables the wireless communications device 30 to transmit and receive SRWC signals, such as BLE signals. The SRWC circuit may allow the device 30 to connect to another SRWC device. Additionally, in some embodiments, the wireless communications device may contain a cellular chipset 34 thereby allowing the device to communicate via one or more cellular protocols, such as those used by cellular carrier system 70.

Wireless communications device 30 may enable vehicle 12 to be in communication with one or more remote networks via packet-switched data communication. This packet-switched data communication may be carried out through use of a non-vehicle wireless access point that is connected to a land network via a router or modem. When used for packet-switched data communication such as TCP/IP, the communications device 30 can be configured with a static IP address or can be set up to automatically receive an assigned IP address from another device on the network such as a router or from a network address server.

Packet-switched data communications may also be carried out via use of a cellular network that may be accessible by the device 30. Communications device 30 may, via cellular chipset 34, communicate data over wireless carrier system 70. In such an embodiment, radio transmissions may be used to establish a communications channel, such as a voice channel and/or a data channel, with wireless carrier system 70 so that voice and/or data transmissions can be sent and received over the channel. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known to those skilled in the art. It should be appreciated that mobile device 90 can include a cellular chipset and/or other communicating means that can be used for packet-switched data communications.

Processor 36 can be any type of device capable of processing electronic instructions including microprocessors, microcontrollers, host processors, controllers, vehicle communication processors, and application specific integrated circuits (ASICs). It can be a dedicated processor used only for communications device 30 or can be shared with other vehicle systems. Processor 36 executes various types of digitally-stored instructions, such as software or firmware programs stored in memory 38, which enable the device 30 to provide a wide variety of services. For instance, at least in one embodiment, processor 36 can execute programs or process data to carry out at least a part of the method discussed herein, which can include performing speech arbitration using a neural network model. Memory 38 may include RAM, other temporary powered memory, any non-transitory computer-readable medium (e.g., EEPROM), or any other electronic computer medium that stores some or all of the software needed to carry out the various external device functions discussed herein.

In one embodiment, the wireless communications device 30 may operate both when the vehicle is in a powered on state and when the vehicle is in a powered off state. As used herein, a “powered on state” is a state of the vehicle in which the ignition or primary propulsion system of the vehicle is powered on and, as used herein, a “powered off state” is a state of the vehicle in which the ignition or primary propulsion system of the vehicle is not powered on. The operation or state of the wireless communications device 30 may be controlled by another vehicle system module, such as by BCM 26 or by an infotainment module. In the powered on state, the wireless communications device 30 may always be kept “on” or supplied with power from a vehicle battery or other power source. In the powered off state, the wireless communications device 30 may be kept in a low-power mode or may be supplied power periodically so that device 30 may wake up and perform operations.

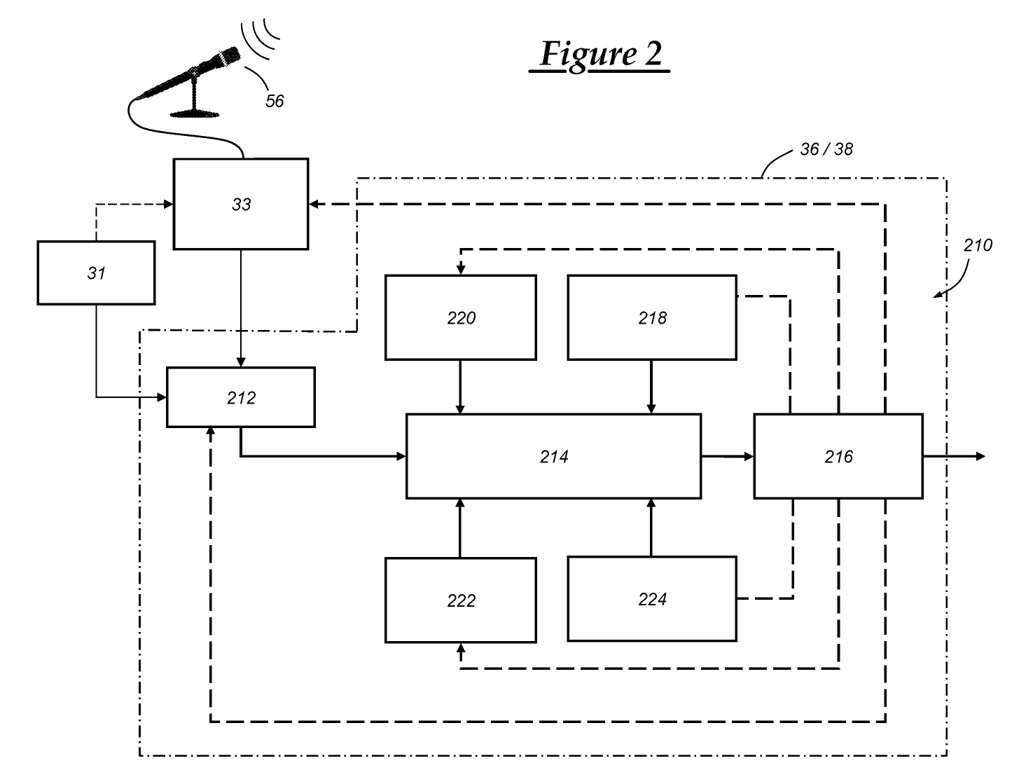

Turning now to FIG. 2, there is shown an illustrative architecture for an ASR system 210 that can be used to enable the presently disclosed method. Although the ASR system 210 is discussed below with respect to wireless communications device 30 of vehicle 12, the ASR system 210 can be incorporated into any client device, such as those discussed above including mobile device 90 and computers 78. An ASR system that is similar or the same to ASR system 210 can be incorporated into one or more remote speech processing servers, including one or more servers located at remote facility 80. In general, a vehicle occupant vocally interacts with an automatic speech recognition (ASR) system for one or more of the following fundamental purposes: training the system to understand a vehicle occupant's particular voice; storing discrete speech such as a spoken nametag or a spoken control word like a numeral or keyword; or recognizing the vehicle occupant's speech for any suitable purpose such as voice dialing, menu navigation, transcription, service requests, vehicle device or device function control, or the like. Generally, ASR extracts acoustic data from human speech, compares and contrasts the acoustic data to stored subword data, selects an appropriate subword which can be concatenated with other selected subwords, and outputs the concatenated subwords or words for post-processing such as dictation or transcription, address book dialing, storing to memory, training ASR models or adaptation parameters, or the like.

ASR systems are generally known to those skilled in the art, and FIG. 2 illustrates just one specific illustrative ASR system 210. The system 210 includes a device to receive speech such as the vehicle microphone 56, and an acoustic interface 33 such as a sound card of the wireless communications device 30 having an analog to digital converter to digitize the speech into acoustic data. The system 210 also includes a memory such as the vehicle memory 38 for storing the acoustic data and storing speech recognition software and databases, and a processor such as the vehicle processor 36 to process the acoustic data. The processor functions with the memory and in conjunction with the following modules: one or more front-end processors or pre-processor software modules 212 for parsing streams of the acoustic data of the speech into parametric representations such as acoustic features; one or more decoder software modules 214 for decoding the acoustic features to yield digital subword or word output data corresponding to the input speech utterances; and one or more post-processor software modules 276 for using the output data from the decoder module(s) 214 for any suitable purpose.

The system 210 can also receive speech from any other suitable audio source(s) 31, which can be directly communicated with the pre-processor software module(s) 212 as shown in solid line or indirectly communicated therewith via the acoustic interface 33. The audio source(s) 31 can include, for example, a telephonic source of audio such as a voice mail system, or other telephonic services of any kind.

One or more modules or models can be used as input to the decoder module(s) 214. First, grammar and/or lexicon model(s) 278 can provide rules governing which words can logically follow other words to form valid sentences. In a broad sense, a grammar can define a universe of vocabulary the system 210 expects at any given time in any given ASR mode. For example, if the system 210 is in a training mode for training commands, then the grammar model(s) 278 can include all commands known to and used by the system 210. In another example, if the system 210 is in a main menu mode, then the active grammar model(s) 278 can include all main menu commands expected by the system 210 such as call, dial, exit, delete, directory, or the like. Second, acoustic model(s) 280 assist with selection of most likely subwords or words corresponding to input from the pre-processor module(s) 212. Third, word model(s) 222 and sentence/language model(s) 224 provide rules, syntax, and/or semantics in placing the selected subwords or words into word or sentence context. Also, the sentence/language model(s) 224 can define a universe of sentences the system 210 expects at any given time in any given ASR mode, and/or can provide rules, etc., governing which sentences can logically follow other sentences to form valid extended speech.

According to an alternative illustrative embodiment, some or all of the ASR system 210 can be resident on, and processed using, computing equipment in a location remote from the vehicle 12, such as the computer 78 or the remote facility 80. For example, grammar models, acoustic models, and the like can be stored in memory of one of the servers and/or databases in the remote facility 80 and communicated to the vehicle wireless communications device 30 for in-vehicle speech processing. Similarly, speech recognition software can be processed using processors of one of the remote servers in the remote facility 80. In other words, the ASR system 210 can be resident in the wireless communications device 30, distributed across the computer 78/remote facility 80 and the vehicle 12 in any desired manner, and/or resident at the computer 78 or remote facility 80.

First, acoustic data is extracted from human speech wherein a vehicle occupant speaks into the microphone 56, which converts the utterances into electrical signals and communicates such signals to the acoustic interface 33. A sound-responsive element in the microphone 56 captures the occupant's speech utterances as variations in air pressure and converts the utterances into corresponding variations of analog electrical signals such as direct current or voltage. The acoustic interface 33 receives the analog electrical signals, which are first sampled such that values of the analog signal are captured at discrete instants of time, and are then quantized such that the amplitudes of the analog signals are converted at each sampling instant into a continuous stream of digital speech data. In other words, the acoustic interface 33 converts the analog electrical signals into digital electronic signals. The digital data are binary bits which are buffered in the memory 38 of wireless communications device 30 and then processed by the processor 36 of wireless communications device 30 or can be processed as they are initially received by the processor 36 in real-time.

Second, the pre-processor module(s) 212 transforms the continuous stream of digital speech data into discrete sequences of acoustic parameters. More specifically, the processor 36 executes the pre-processor module(s) 212 to segment the digital speech data into overlapping phonetic or acoustic frames of, for example, 10-30 millisecond (ms) duration. The frames correspond to acoustic subwords such as syllables, demi-syllables, phones, diphones, phonemes, or the like. The pre-processor module(s) 212 also performs phonetic analysis to extract acoustic parameters from the occupant's speech such as time-varying feature vectors, from within each frame. Utterances within the occupant's speech can be represented as sequences of these feature vectors. For example, and as known to those skilled in the art, feature vectors can be extracted and can include, for example, vocal pitch, energy profiles, spectral attributes, and/or cepstral coefficients that can be obtained by performing Fourier transforms of the frames and decorrelating acoustic spectra using cosine transforms. Acoustic frames and corresponding parameters covering a particular duration of speech are concatenated into unknown test pattern of speech to be decoded.

Third, the processor executes the decoder module(s) 214 to process the incoming feature vectors of each test pattern. The decoder module(s) 214 is also known as a recognition engine or classifier, and uses stored known reference patterns of speech. Like the test patterns, the reference patterns are defined as a concatenation of related acoustic frames and corresponding parameters. The decoder module(s) 214 compares and contrasts the acoustic feature vectors of a subword test pattern to be recognized with stored subword reference patterns, assesses the magnitude of the differences or similarities therebetween, and ultimately uses decision logic to choose a best matching subword as the recognized subword. In general, the best matching subword is that which corresponds to the stored known reference pattern that has a minimum dissimilarity to, or highest probability of being, the test pattern as determined by any of various techniques known to those skilled in the art to analyze and recognize subwords. Such techniques can include dynamic time-warping classifiers, artificial intelligence techniques, neural networks, free phoneme recognizers, and/or probabilistic pattern matchers such as Hidden Markov Model (HMM) engines.

HMM engines are known to those skilled in the art for producing multiple speech recognition model hypotheses of acoustic input. The hypotheses are considered in ultimately identifying and selecting that recognition output which represents the most probable correct decoding of the acoustic input via feature analysis of the speech. More specifically, an HMM engine generates statistical models in the form of an “N-best” list of subword model hypotheses ranked according to HMM-calculated confidence values or probabilities of an observed sequence of acoustic data given one or another subword such as by the application of Bayes' Theorem.

A Bayesian HMM process identifies a best hypothesis corresponding to the most probable utterance or subword sequence for a given observation sequence of acoustic feature vectors, and its confidence values can depend on a variety of factors including acoustic signal-to-noise ratios associated with incoming acoustic data. The HMM can also include a statistical distribution called a mixture of diagonal Gaussians, which yields a likelihood score for each observed feature vector of each subword, which scores can be used to reorder the N-best list of hypotheses. The HMM engine can also identify and select a subword whose model likelihood score is highest.

In a similar manner, individual HMMs for a sequence of subwords can be concatenated to establish single or multiple word HMM. Thereafter, an N-best list of single or multiple word reference patterns and associated parameter values may be generated and further evaluated.

In one example, the speech recognition decoder 214 processes the feature vectors using the appropriate acoustic models, grammars, and algorithms to generate an N-best list of reference patterns. As used herein, the term reference patterns is interchangeable with models, waveforms, templates, rich signal models, exemplars, hypotheses, or other types of references. A reference pattern can include a series of feature vectors representative of one or more words or subwords and can be based on particular speakers, speaking styles, and audible environmental conditions. Those skilled in the art will recognize that reference patterns can be generated by suitable reference pattern training of the ASR system and stored in memory. Those skilled in the art will also recognize that stored reference patterns can be manipulated, wherein parameter values of the reference patterns are adapted based on differences in speech input signals between reference pattern training and actual use of the ASR system. For example, a set of reference patterns trained for one vehicle occupant or certain acoustic conditions can be adapted and saved as another set of reference patterns for a different vehicle occupant or different acoustic conditions, based on a limited amount of training data from the different vehicle occupant or the different acoustic conditions. In other words, the reference patterns are not necessarily fixed and can be adjusted during speech recognition.

Using the in-vocabulary grammar and any suitable decoder algorithm(s) and acoustic model(s), the processor accesses from memory several reference patterns interpretive of the test pattern. For example, the processor can generate, and store to memory, a list of N-best vocabulary results or reference patterns, along with corresponding parameter values. Illustrative parameter values can include confidence scores of each reference pattern in the N-best list of vocabulary and associated segment durations, likelihood scores, signal-to-noise ratio (SNR) values, and/or the like. The N-best list of vocabulary can be ordered by descending magnitude of the parameter value(s). For example, the vocabulary reference pattern with the highest confidence score is the first best reference pattern, and so on. Once a string of recognized subwords are established, they can be used to construct words with input from the word models 222 and to construct sentences with the input from the language models 224.

Finally, the post-processor software module(s) 276 receives the output data from the decoder module(s) 214 for any suitable purpose. In one example, the post-processor software module(s) 276 can identify or select one of the reference patterns from the N-best list of single or multiple word reference patterns as recognized speech. In another example, the post-processor module(s) 276 can be used to convert acoustic data into text or digits for use with other aspects of the ASR system or other vehicle systems. In a further example, the post-processor module(s) 276 can be used to provide training feedback to the decoder 214 or pre-processor 212. More specifically, the post-processor 276 can be used to train acoustic models for the decoder module(s) 214, or to train adaptation parameters for the pre-processor module(s) 212.

And, as will be evident from the discussion below, the ASR system can be included in a client device, such as vehicle 12 or mobile device 90, and/or included in a server device, such as a server located at remote facility 80. At least according to some embodiments, the ASR system located at the remote server can include more processing power, as well as more speech recognition information that can be used to provide a more powerful ASR system than that which is located at the client device; however, as those skilled in the art will appreciate, other embodiments exist.

The ASR system or parts thereof can be implemented in a computer program product embodied in a computer readable medium and including instructions usable by one or more processors of one or more computers of one or more systems to cause the system(s) to implement the neural network speech arbitration process. The computer program product may include one or more software programs comprised of program instructions in source code, object code, executable code or other formats; one or more firmware programs; or hardware description language (HDL) files; and any program related data. The data may include data structures, look-up tables, or data in any other suitable format. The program instructions may include program modules, routines, programs, objects, components, and/or the like. The computer program can be executed on one computer or on multiple computers in communication with one another.

The program(s) can be embodied on computer readable media, which can be non-transitory and can include one or more storage devices, articles of manufacture, or the like. Exemplary computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium may also include computer to computer connections, for example, when data is transferred or provided over a network or another communications connection (either wired, wireless, or a combination thereof). Any combination(s) of the above examples is also included within the scope of the computer-readable media. It is therefore to be understood that the method can be at least partially performed by any electronic articles and/or devices capable of carrying out instructions corresponding to one or more steps of the disclosed method.

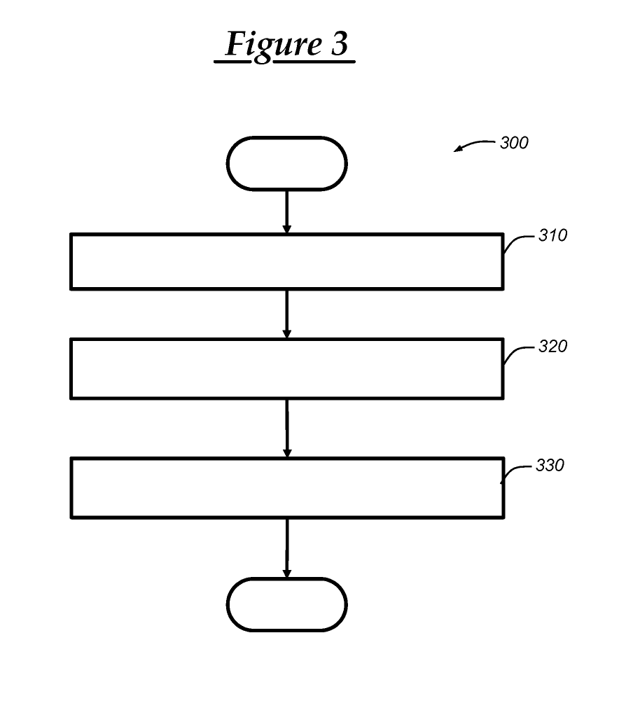

Turning now to FIG. 3, there is shown an embodiment of a method (300) of performing speech arbitration using a neural network speech arbitration process. As used herein, “neural network speech arbitration process” refers to a process that performs speech arbitration and that is based on an artificial neural network computing process or model. The neural network speech arbitration process can be implemented on processor 36 of wireless communications device 30 in vehicle 12 and/or may be implemented on another VSM of vehicle 12. The neural network speech arbitration process may be implemented on wireless communications device 30 (or other VSM) by configuring the device 30 with a neural network speech arbitration application, which may be in the form of software and/or firmware instructions or a part of a computer program product. The neural network speech arbitration application can be initially configured and/or compiled at a remote facility, such as remote facility 80, and may be installed on the wireless device 30 (or other client device) via use of a provisioning process or initial manufacture process that can be carried out before, during, or after sale of vehicle 12 (or other client device).

At least in one embodiment, the neural network speech arbitration application may initially include a set of computer instructions and a set of initial speech arbitration information to be used during the neural network speech arbitration process. The set of computer instructions can use the set of initial speech arbitration information to carry out the neural network speech arbitration process. The neural network speech arbitration application can be generated and/or initially trained using various training information, including information gathered from previous iterations of speech arbitration processes, including rule-based speech arbitration processes. The neural network speech arbitration application can be periodically updated and/or trained so as to improve the speech arbitration process. This can include using inputs and outputs of previous neural network speech arbitration process iterations (as well as performance indicators) as training information for the neural network speech arbitration application. Additionally, other training information (e.g., sets of inputs and their corresponding or desired outputs), as well as updated software/firmware instructions can be sent to the client device from a remote server, such as remote facility 80.

The training of the neural network speech arbitration process or application can be carried out before the neural network speech arbitration application is installed on the client device and/or before the neural network speech arbitration application is configured for use in the client device. Moreover, the initial training can supervised training that uses training information (inputs, outputs, and accuracy of outputs) that was obtained from previous speech arbitration models, including rule-based speech arbitration applications. In other embodiments, the initial training can be unsupervised training. The initial training can be carried out at a remote facility, such as remote facility 80, and, when the initial training is complete and the client device is ready to be configured for use, the neural network speech arbitration application can be installed. The neural network speech arbitration application can be included as a part or module of a speech recognition application and may be carried out and/or integrated in a similar manner as the ASR system discussed above.

Additionally, the neural network model that is used in the neural network speech arbitration process or application can be a shallow neural network or a deep neural network. As used herein, a shallow neural network includes a single hidden layer whereas a deep neural network includes a plurality of hidden layers. Each layer of the neural network may include one or more nodes, each of which may map to one or more other nodes within the same hidden layer, to one or more other nodes within another hidden layer, or to one or more output nodes.

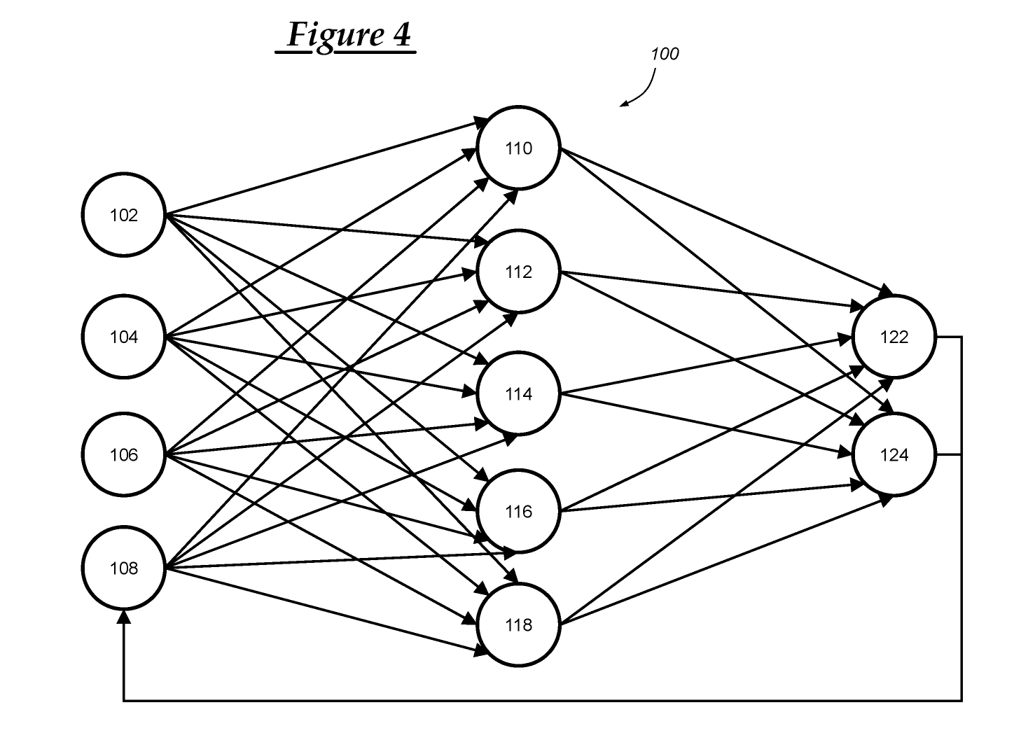

For example, FIG. 4 depicts an example neural network model that can be used in the neural network speech arbitration process. The neural network model 100 includes a set of input nodes 102-108, speech arbitration output nodes 122-124, and a hidden layer that includes nodes 110-118. The set of input nodes 102-108 can each correspond to a different input, including a confidence score, a connectivity quality metric, an engine bias metric, and conditional input. The hidden layer, including nodes 110-118, can be used to map the inputs to the appropriate output. The speech arbitration output nodes 122-124 can correspond to an ASR system in which to perform the speech processing of the received speech signals, such as a first ASR system at the client device (e.g., vehicle 12) or a second ASR system at the remote server. In one embodiment, node 108 can represent conditional input that can be used in the set of inputs to the neural network speech arbitration process and, as shown in FIG. 4, the conditional input can include feedback from the speech arbitration output, which may comprise output nodes (e.g., nodes 122 and 124) for each of the ASR systems.

Method 300 begins with step 310, wherein speech signals are received at the client device. As mentioned above, the client device may be one of a variety of devices, including vehicle 12, mobile device 90, and/or computer 78; however, the method 300 is discussed using vehicle 12 as the client device. Vehicle 12 can receive the speech signals using microphone 56 at wireless communications device 30. The speech signals can be sampled so that a digital representation of the speech signals can be obtained and used by the processor 36. The sampling can be carried out at the microphone 56, at the wireless communications device 30, or at another VSM of vehicle 12. Once the speech signals have been received and sampled, method 300 continues to step 320.

In step 320, a set of inputs are obtained that can be used in the neural network speech arbitration process. Various inputs can be used in the neural network speech arbitration process, including any or all of those that are used as inputs in conventional speech arbitration processes including rule-based speech arbitration processes. According to one embodiment, the set of inputs includes a confidence score metric, a connectivity quality metric, an engine bias metric, and conditional input. Any one or more of these metrics can be determined at the time that step 320 is reached—i.e., after the speech signals are received—or can be determined at a prior time and saved in a memory located at the client device, such as memory 38 of wireless communications device 30. According to the latter scenario, upon step 320 being reached, one or more metrics that will be used in the set of inputs to the speech arbitration process can be recalled from the memory device.

In some embodiments, the neural network speech arbitration process can take a confidence score (or confidence value) as an input. The confidence score can represent a likelihood that the ASR system of the client device is to be able to recognize the speech conveyed in the received speech signals. The confidence score can be determined through using any of the methods discussed above, including the Bayesian HMM process.

Also, the neural network speech arbitration process can take a connectivity quality metric as an input. The connectivity quality metric can represent the present network connectivity of the client device to a network, including the Internet or a remote network, such as a remote network that is present at remote facility 80. In some embodiments, the connectivity quality metric can represent a quality of service with respect to the remote speech processing facility. For example, when quality of service is low or poor, it may be more beneficial, at least in some embodiments, to carry out the speech recognition at the client device (or a second remote speech processing facility) than at the remote speech processing facility. Thus, when there is a low quality of service or connectivity quality metric, the neural network speech arbitration application may be more likely to carry out the speech processing at the client device than at the remote device. In one embodiment, the vehicle can determine a present connectivity quality by sending a connectivity test signal from the vehicle to a remote server, such as a remote server included at remote facility 80.

Additionally, other metrics and/or values can be used in the set of inputs that are used for the neural network speech arbitration process, including an engine bias metric and conditional input. The engine bias metric can be a metric that is used to bias the speech arbitration neural network process so that either the client device or the remote server is more likely to be used for the speech recognition processing of the received speech signals. The engine bias can be set to assign different weight to the various ASR systems or engines that may be used for the speech recognition processing. For example, if a particular ASR system is capable of more accurate speech recognition than another, then the engine bias can be set based on the capabilities of the various speech recognition systems.

In another example, the ASR system of the client device may recognize one or more initial words that were conveyed in the spoken speech signals and, based on the initial words, the system can change the engine bias metric input. For example, the client device's ASR system may determine that a user is requesting a song based on recognizing the term “play.” The vehicle may determine that the subsequent speech signals most likely correspond to a song included in the user's audio library that is stored on the client device and, thus, that the client device's ASR system is in a more advantageous position (relative to the remote server) for recognizing the speech contained in the speech signals. Thus, the engine bias metric for the client device may be higher than usual (or higher than a default value), or may be set higher than a corresponding engine bias metric for the remote server's ASR system. Additionally, the vehicle state (or client device state) can be used as a basis for setting the engine bias metric. For example, in one scenario, when the vehicle is in a powered off state, there may be only a few commands that the vehicle will respond to. Thus, it may be beneficial to use the vehicle's ASR to perform the speech recognition processing since there may only be a few possible valid spoken inputs and, therefore, sending the speech signals to a remote server for speech recognition processing may prove to use more resources than necessary so as to achieve a successful response by the client device.

The conditional input, which may be included in the set of inputs that are to be used by the neural network speech arbitration process, can be based on output of a previous iteration of the neural network speech arbitration process. Some embodiments may use a recurrent neural network (RNN) model and, in such embodiments, the output of one speech arbitration process (e.g., for a first subword, word, or phrase of the speech signals) can be used to affect subsequent speech arbitration iterations, such as those of a second subword, word, or phrase of the speech signals. Once the set of inputs are generated and/or obtained, the method 300 continues to step 330.

In step 330, a speech arbitration output is received that indicates whether and/or to what extent the speech recognition processing of the received speech signals is to be carried out at the client device or at the remote server. The speech arbitration output can include which ASR system will be used for the speech recognition processing of the received speech signals. Alternatively, or additionally, the speech arbitration output can include an indicator that indicates which speech signals will be processed by which ASR system and/or which ASR processes are to be carried out by a certain ASR system. For example, the ASR system may determine that certain speech signals may be processed using the ASR system of the client device, which may be included in wireless device 30, as discussed above.

After it is determined whether and/or to what extent the speech recognition processing of the received speech signals is to be carried out at the client device or at the remote server, then the speech signals can be sent to such ASR system based on this determination. For example, when it is determined that the remote server will be used for speech recognition processing of the speech signals, then the speech signals may be packaged into one or more messages and sent via cellular carrier system 70 and land network 76 to the remote server. The vehicle 12 may then receive a response back from the remote server that indicates one or more actions, requests, words, or commands conveyed by a user in the speech signals.

At least in some embodiments, the neural network speech arbitration process and/or application can adapt based on previous iterations. In one embodiment, the neural network speech arbitration process can adapt by retaining the set of inputs of a given iteration and the speech arbitration output for the given iteration. Additionally, the client device can determine a measured success of the given iteration based on one or more performance indicators. The performance indicators can include the time taken to perform the speech recognition, the accuracy of the speech recognition (which may be indicated by a user's response), and/or other indications of the accuracy and/or efficiency of the speech arbitration and recognition. In some embodiments, any one or more of the set of inputs can be used as a performance indicators. The method 300 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive or. As an example, the phrase “A, B, and/or C” includes: “A”; “B”; “C”; “A and B”; “A and C”; “B and C”; and “A, B, and C.”

1. A method of performing speech arbitration at a client device that includes a neural network speech arbitration application, wherein the neural network speech arbitration application is configured to implement a neural network speech arbitration process, and wherein the method comprises:
receiving speech signals at a client device;
generating and/or obtaining a set of inputs to be used in a speech arbitration neural network process, wherein the speech arbitration neural network process uses a neural network model that is tailored to speech arbitration and that can be used to determine whether and/or to what extent speech recognition processing of the received speech signals should be carried out at the client device or at a remote server; and
receiving a speech arbitration output that indicates whether and/or to what extent the speech recognition processing of the received speech signals is to be carried out at the client device or at the remote server.

2. The method of claim 1, wherein the set of inputs includes conditional input that is generated based on receiving feedback from one or more previous iterations of the speech arbitration neural network process.

3. The method of claim 2, wherein the set of inputs further includes a connectivity quality metric that indicates a quality of service and/or a connection quality between the client device and the remote server.

4. The method of claim 3, wherein the set of inputs further includes a confidence score that is generated based on the received speech signals and that indicates a confidence level pertaining to the client device's ability to successfully recognize spoken words conveyed in the received speech signals.

5. The method of claim 4, wherein the set of inputs further includes an engine bias metric that is used to bias the speech arbitration neural network process so that the client device or the remote server is more likely to be used for the speech recognition processing of the received speech signals.

6. The method of claim 1, wherein the speech arbitration neural network process is based on a deep neural network model that includes a plurality of hidden neural network layers that are used to map the set of inputs to the speech arbitration output.

7. The method of claim 1, wherein the speech arbitration neural network process is initially trained using speech recognition output that is obtained as a result of a rule-based speech arbitration process.

8. The method of claim 7, wherein the speech arbitration neural network process uses the speech arbitration output for purposes of training the speech arbitration neural network process so as to improve the neural network speech arbitration process for future iterations.

9. A method of performing speech arbitration at a client device that includes a neural network speech arbitration application, the method comprising:
training the neural network speech arbitration application using training data that is obtained as a result of a rule-based speech arbitration process;
carrying out an iteration of the neural network speech arbitration application at the client device such that speech arbitration is performed, wherein the neural network speech arbitration application uses an artificial neural network model to resolve a set of inputs to a speech arbitration output, and wherein the speech arbitration output indicates whether and/or to what extent to perform speech recognition processing of received speech at a remote server that includes an automated speech recognition (ASR) system; and
adapting the neural network speech arbitration application based on previous iterations of the neural network speech arbitration application.

10. The method of claim 9, wherein the set of inputs includes a confidence score, a connectivity quality metric, an engine bias metric, and conditional input, and wherein the conditional input is based on previous iterations of the neural network speech arbitration application.

11. The method of claim 10, wherein the conditional input is at least partly based on speech arbitration inputs and outputs that are used or obtained as part of previous iterations of the neural network speech arbitration application.

12. The method of claim 11, wherein the adapting step further comprises adapting the neural network speech arbitration application based on the set of inputs, the speech arbitration output, and a measured success of the neural network speech arbitration application.

13. The method of claim 12, wherein the measured success of the neural network speech arbitration process is determined automatically by the client device based on one or more performance indicators.

14. The method of claim 9, wherein the training step further includes performing supervised training on the neural network speech arbitration application using the training data that is obtained as the result of the rule-based speech arbitration process.

15. The method of claim 14, wherein the training step is carried out before the neural network speech arbitration application is installed and configured for use in the client device.

16. The method of claim 15, wherein the network speech arbitration application is occasionally updated through receiving information at the client device from a remotely-located server.

17. A method of performing speech arbitration at a client device that includes a neural network speech arbitration application, wherein the method is carried out by a vehicle that includes a first automated speech recognition (ASR) system, and wherein the method comprises:
training the neural network speech arbitration application using training data;
carrying out a plurality of iterations of the neural network speech arbitration application at the client device such that speech arbitration is performed, wherein each iteration of the plurality of iterations includes:
receiving speech signals at the vehicle;
generating and/or obtaining a set of inputs to be used in a speech arbitration neural network process; and
receiving a speech arbitration output that indicates whether and/or to what extent the speech recognition processing of the received speech signals is to be carried out at the vehicle or at a remote server that includes a second ASR system; and
adapting the neural network speech arbitration application based on the plurality of iterations of the neural network speech arbitration application.

18. The method of claim 17, wherein the set of inputs includes a confidence score, a connectivity quality metric, an engine bias metric, and conditional input, wherein the conditional input is based on previous iterations of the neural network speech arbitration application.

19. The method of claim 17, wherein the training data is obtained as a result of a rule-based speech arbitration process.

20. The method of claim 19, wherein the training step further includes performing supervised training on the neural network speech arbitration application using the training data that is obtained as the result of the rule-based speech arbitration process, and wherein the training step is carried out before the neural network speech arbitration application is installed and configured for use in the client device.
